(19) United States
(12) Patent Application Publication
(10) Pub. No.: US 2026/0162146 A1
(43) Pub. Date: Jun. 11, 2026

(54) MATCH BACK SYSTEMS AND METHODS FOR LOCATION-BASED TARGETING OF RENTAL UNIT MARKETING

(71) Applicant: Connect Digital, Inc., Louisville, KY (US)

(72) Inventor: Todd R. Allen, Louisville, KY (US)

(21) Appl. No.: 19/179,755

(22) Filed: Apr. 15, 2025

Related U.S. Application Data
(60) Provisional application No. 63/643,707, filed on May 7, 2024.

(51) Int. Cl. G06Q 30/0251; G06Q 30/0242

(52) U.S. Cl. CPC G06Q 30/0261; G06Q 30/0246

(57) ABSTRACT

Methods and systems are described for leveraging location-based technology, often known as “geofencing” to enhance match back analysis for marketing campaigns. Embodiments go beyond just generating leads; embodiments excel at precisely linking applicants to the ad target locations, allowing for unparalleled source attribution. Unlike other marketing tools or geofencing solutions, embodiments disclosed hereunder don't stop at mere lead generation—they provide a revolutionary approach to identify the lead source attribution of the applicant.

### PRIORITY

This application claims the benefit of U.S. Pat. App. No. 63/643,707, entitled “MATCH BACK SYSTEMS AND METHODS FOR LOCATION-BASED TARGETING OF RENTAL UNIT MARKETING,” filed May 7, 2024, the disclosure of which is incorporated by reference herein in its entirety.

### TECHNICAL FIELD

The present disclosure generally relates to systems and methods for matching location-based advertising with geo-fencing-based rental and real estate marketing, match back and analysis.

### BACKGROUND

Returns on marketing campaigns can be difficult to measure. This is true in the real estate and rental unit marketplaces. It can be hard to determine how successful different advertising campaigns are, such as online, radio, social networks, etc. Some prior art has attempted to solve some or similar issues, but they all have drawbacks. Most of the prior art is in the area of geo-fencing or targeted advertisements, with little ability to measure marketing campaign success. Funnel Science™ has one related product. It lacks the ability for matching applicants to ad serve location and is focused on lead generation and tracking. Funnel can track leads, but is intertwined with Google Ads™. RealPage™ offers geofencing and lead generation, but no match back capability. Cidewalk Technologies™ describes sending digital advertisements for unsophisticated users using geofencing platform. They offer a platform but it does little more than offer ad creation functionalities. Westerberg Mahnaz™ describes a system for automatic creation of a real estate magazine. Mobilebits Corp™ describes a DSP (demand side platform) and front-end advertisement distribution, without match back functionality. Zimmerman /Rentvision™ is a digital marketing suite with a focus on website building, PPC (pay per click) advertisements, etc. Moocentric™, Choozle™, and Stancato Enzo™ similarly offer some marketing functionality, but little else.

### SUMMARY

One embodiment under the present disclosure comprises a method for aggregating location data and marketing data. The method comprises receiving one or more marketing data from one or more marketing servers configured to transmit one or more advertisements to one or more users; receiving one or more location data related to one or more views by the one or more users of the one or more advertisements; and receiving one or more applicant data from a client apartment complex, the one or more applicant data comprising at least one or more previous addresses. The method further comprises comparing the one or more location data and the one or more previous addresses to determine one or more previous apartment complexes; and providing a report to the client apartment complex regarding the one or more previous apartment complexes.

Another embodiment under the present disclosure comprises a system for aggregating location data and marketing data. The system comprises a marketing interface configured to receive one or more marketing data from one or more marketing servers configured to transmit one or more advertisements to one or more users; a geo-fencing interface configured to receive one or more location data related to one or more views by the one or more users of the one or more advertisements; and an apartment interface configured to receive one or more applicant data from a client apartment complex, the one or more applicant data comprising at least one or more previous addresses. The system further comprises one or more match back servers coupled to the marketing, geo-fencing, and apartment interfaces, and configured to compare the one or more location data and the one or more previous addresses to determine one or more previous apartment complexes; and further configured to provide a report to the client apartment complex regarding the one or more previous apartment complexes.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one embodiment of a match back system under the present disclosure;

FIG. 2 shows an example embodiment of a user interface under the present disclosure;

FIG. 3 shows an example embodiment of a user interface under the present disclosure;

FIG. 4 shows an example embodiment of a user interface under the present disclosure;

FIG. 5 shows an example embodiment of a user interface under the present disclosure;

FIG. 6 shows an example embodiment of a user interface under the present disclosure;

FIG. 7 shows an example embodiment of a user interface under the present disclosure;

FIG. 8 shows an example embodiment of a user interface under the present disclosure;

FIG. 9 shows an example embodiment of a user interface under the present disclosure;

FIG. 10 illustrates a possible method embodiment under the present disclosure; and

FIG. 11 shows an embodiment of a computing device for use in various embodiments under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the realm of rental unit marketing and match back analysis. Traditional marketing tools like ILSs (internet listing sites) (such as apartments. com), social media, Google™ PPC and SEO (search engine optimization), and paid advertisements may generate leads, but they fall short when it comes to providing clear source attribution. These tools lack the ability to offer meaningful insights into the actual value they bring to a property as rent-paying residents.

Certain aspects of the embodiments disclosed herein can provide solutions to these or other challenges. Embodiments under the present disclosure can leverage location-based technology, often known as “geofencing.” Embodiments can go beyond just generating leads; embodiments can excel at precisely linking applicants to the advertisement target locations, allowing for unparalleled source attribution. Unlike other marketing tools or geofencing solutions, embodiments disclosed hereunder don't stop at mere lead generation—they can provide systems and methods to identify the lead source attribution of the applicant.

Certain embodiments may provide one or more of the following technical advantages over the prior art. Certain embodiments can include the unique ability to combine lead source attribution with standard applicant data, such as lease rent and term. This integration empowers real estate operators with comprehensive insights, allowing them to not only track leads but also evaluate the true impact of their marketing efforts. While other prior art solutions may only showcase leads, certain embodiments under the present disclosure can yield more date, such as by analyzing, measuring, or otherwise revealing the campaign ROI (return on investment), giving a complete picture of marketing ROI. Embodiments can elevate the apartment operator experience and transforms a client's marketing strategy from simply generating leads to achieving measurable and meaningful results.

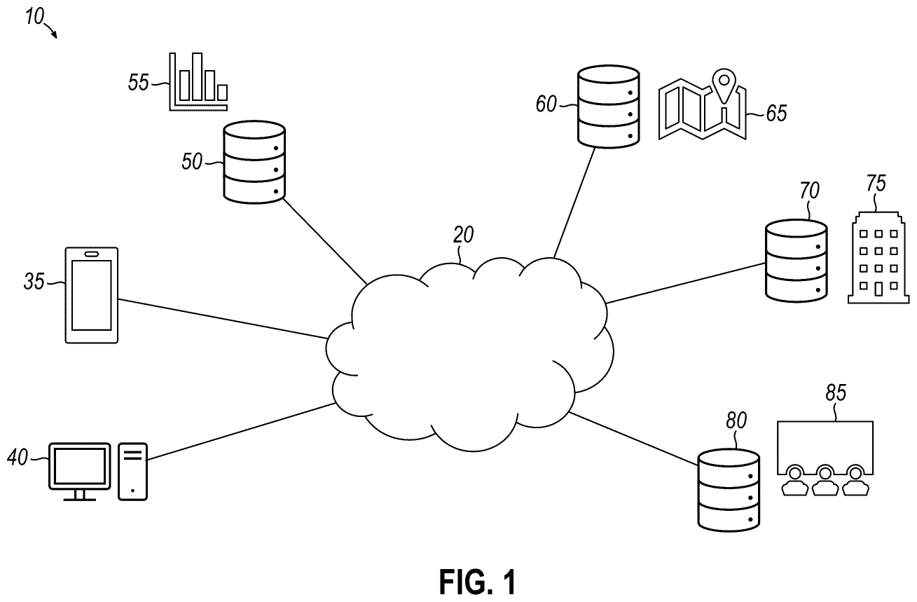

FIG. 1 illustrates one system embodiment 10 under the present disclosure. System 10 can comprise an apartment marketing match back system 10. Match back services 55 comprising match back server 50 may provide rental, marketing, auditing and/or match back analysis related to rental, location and/or marketing data. Match back analysis includes matching applications which may become leases with preceding marketing campaigns and related location data to ascertain fertile locations or targets for marketing techniques. Match back server 50 may monitor, store or track a variety of data, including rental and applicant data from one or more apartment complexes 75, which data may be stored or accessed via one or more apartment data servers 70. Match back server 50 may monitor, store or track location data from one or more location services 65 (e.g., geo-fencing services), which data may be stored or accessed via one or more location servers 60. Match back server 50 may monitor, store or track marketing data from one or more marketing services 85, which data may be stored or accessed via one or more marketing servers 80. In some embodiments one or more of apartment data servers 70, location servers 60, match back server 50, and/or marketing servers 80 may be combined. For example, in some embodiments marketing data and rental/application data may be stored together in a CRM (consumer resource management) server managed by an apartment complex 75. Any servers in FIG. 1 may be cloud-based or on-premise (“on-prem”). Network 20 may provide communicative coupling amongst various components of system 10. Network 20 can comprise the Internet, enterprise/LAN systems, cellular networks, other types of data networks, and/or combinations of any of the foregoing. In some embodiments match back servers 50 may comprise an interface that is communicatively coupled to location servers 60, apartment data servers 70, and/or marketing servers 80, such as user interface for data entry, APIs (application programming interfaces), or other communicative coupling means. Communicative coupling can be via network 20, or via other networking mechanisms or technologies. In some embodiments, some or all of the functionalities described with respect to match back servers 50, location servers 60, apartment data servers 70, and/or marketing servers 80 may be co-located.

In some embodiments, computing devices, such as mobile device 35 or computer 40, may be used by consumers or users of system 10 to access e.g., data from match back server 50, or to access marketing servers 85 or apartment complexes 75, etc. For example, a consumer may search for nearby apartment complexes on mobile device 35. During this searching process, location data of the user may be tracked by location servers 60 (e.g., Google), marketing campaigns/advertisements may be directed to the mobile device 35 to be shown to the user by marketing servers 80 (e.g., Google Ads, Facebook Ads™, etc.), and/or the user may access a website run by apartment complex 75 provided by apartment data servers 70. In some instances, location data and marketing data may be provided by a single entity, e.g. Google, etc.

In other embodiments, a manager of match back servers 50 may wish to analyze aggregated data related to marketing campaigns run by apartment complex 75, and may access match back servers 50 via computing devices 35, 40 to run marketing or auditing reports.

In certain embodiments, apartment complex 70 may desire to target potential renters in a given geographic area(s) and may partner with or manage one or more of location services 75, marketing services 85, and match back services 55 to implement or audit a marketing campaign. In the market for multifamily apartment operations, one key to financial success is an ability to not just attract applicants but convert them into valuable, rent-paying residents. Embodiments under the present disclosure can implement a strategic and innovative process to identify potential residents residing in nearby competitor communities or working in nearby offices as potential residents, and measure how successful different marketing strategies are in attracting such potential residents.

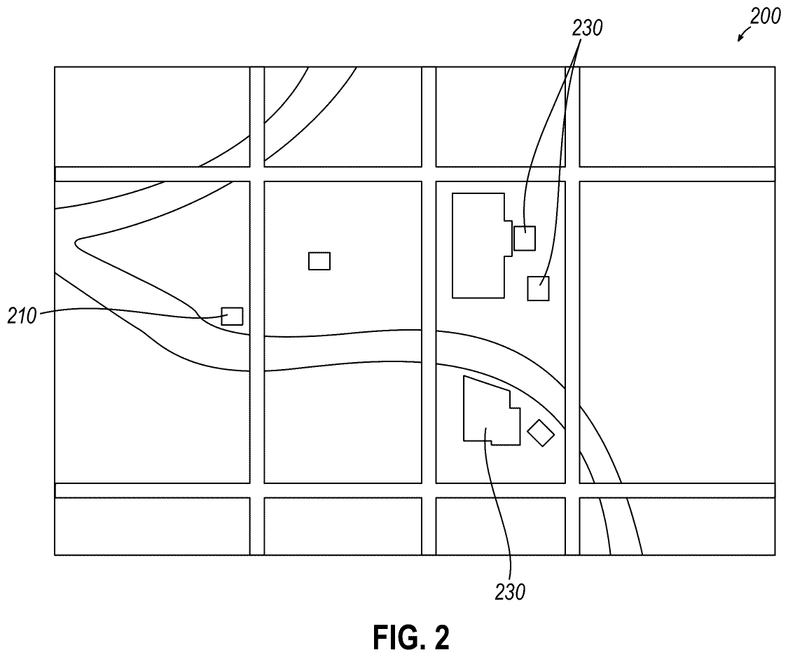

At a computing device 35, 40 a user of system 10 of FIG. 1 (e.g., an apartment manager) may be presented with user interface 200 of FIG. 2 provided by e.g., match back services 55. The user may be associated with apartment complex 210 and may desire to attract potential residents from target apartments 230 in the same city/region (or it could be another region, depending on use case scenarios). Or the user may desire to audit marketing campaign(s) that target such potential residents. Target apartments 230 could be identified by various methods, e.g., all apartments in the area, all apartments in the area with a rent above a given amount, all apartments in an area with a rent below a certain amount, data collected from existing/previous residents at apartment complex 210, other methods, and/or combinations of various methods. Targeting the potential residents with a marketing campaign, and analysis of the marketing campaign, can comprise one or more of the following aspects:
Identification of Prospective Residents: Match back services 55 can work with client apartment complexes 75 to identify target audiences living and/or working in nearby or targeted competitor communities and/or offices who might be potential residents for the client's properties.
Digital Advertisement Deployment: Once identified, prospective residents can receive targeted digital advertisements directly on their mobile phones, tablets, and/or computing devices via e.g., display or banner advertisements. Display advertisements do not require opt-in and are seen on websites and apps that sell advertising. This comprehensive approach can help ensure that advertisements reach the audience on various platforms, maximizing visibility and engagement.
Redirection to Client's Website: Interested prospects may see the advertisement, click the advertisement, and can be seamlessly redirected to a client's website. This can help facilitate a smooth transition from awareness to action, allowing prospects to explore a client's offerings in more detail. There are also scenarios where the display advertisements can “perform” like a billboard advertisement to build awareness with the target audience who direct enters the website, performs a Google search, or ILS search at a later date.
Conversion to Paying Resident: One goal can be to convert these interested prospects into paying residents. By directing them to a client's website, an environment conducive to conversion can be created, providing the necessary information and incentives for prospects to make the decision to become residents.
Accurate Lead Source Attribution: Embodiments under the present disclosure, such as embodiments of match back services 55, may go beyond lead generation by accurately measuring lead source attribution. Embodiments can match the applicant's address back to the advertisement served to target locations to establish attribution from the specific marketing channel. This level of detail may enable clients to make data-driven decisions and optimize their marketing strategies.
ROI Calculation: Armed with information about the lead source, rent, and lease term of the applicant, match back servers 50 can build a robust ROI model. This model can showcase the direct impact and effectiveness of the client's marketing investment, offering a clear and quantifiable measure of success.
Uninterrupted Advertising Experience: To optimize marketing campaigns, advertisements are displayed on the prospect's device without the distraction of competitors'advertisements, unlike a Google search or apartments.com™ search where competitors are produced alongside the advertising community. This ensures that the client's message takes center stage, maximizing the chances of capturing the prospect's attention and driving conversion.

Returning to FIGS. 1 and 2, location services 65 and/or marketing services 85 may identify a target group of consumers, e.g., apartment residents in a given set of zip codes with income between $75,000 and $200,000. Location services 65 and/or marketing services 85 are commonly called demand side platforms (DSPs). Location services 65 and/or marketing services 85 may target this group with advertisements, such as browser advertisements, Facebook ads, and other marketing strategies. Match back servers 50 may manage and/or monitor the actions of location services 65 and/or marketing services 85 in this target advertising process. Match back servers 50 may receive/retrieve data from location servers 60, marketing servers 80, and/or apartment servers 70 in real time, daily, weekly, or at other times. Along with information about targeted advertising campaigns from location servers 60 and/or marketing servers 80, match back servers 50 may also receive/retrieve data from apartment complex 75 about competitor apartment complexes.

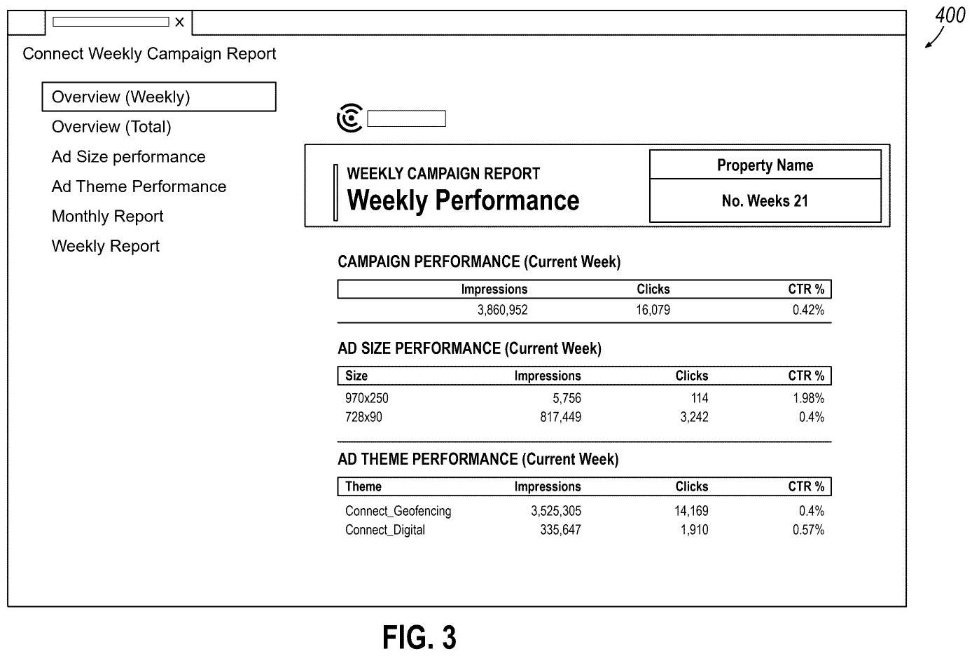

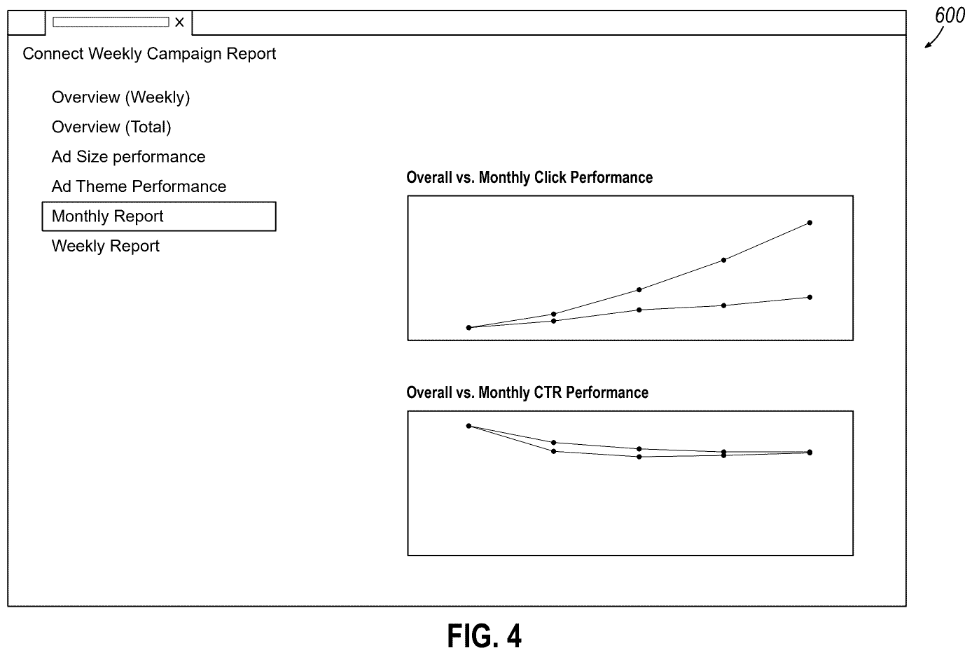

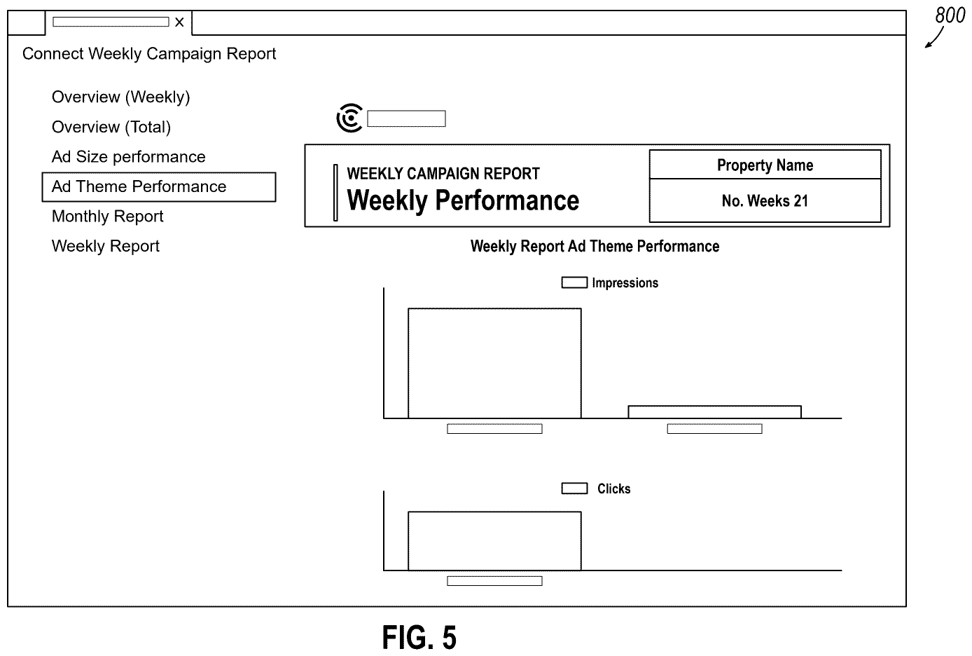

FIG. 3 illustrates a possible embodiment of a marketing report interface 400, e.g., a weekly marketing report. Marketing report interface 400 can show different advertisements, grouped or identified by e.g., size (e.g., 970×250, 728×90, etc.), shape, related marketing campaign (e.g., Connect_Geofencing, Connect_Digital, etc.), or other characteristics, and related metrics such as total clicks and click through rate (CTR). Other data can be shown, such as total impressions or other useful marketing metrics. Data can be shown over time as well, or in graphic form. One example is shown in an embodiment of a marketing report interface 600 shown in FIG. 4, which shows monthly click performance. Another example embodiment is shown in marketing report interface 800 shown in FIG. 5, which shows total impressions data.

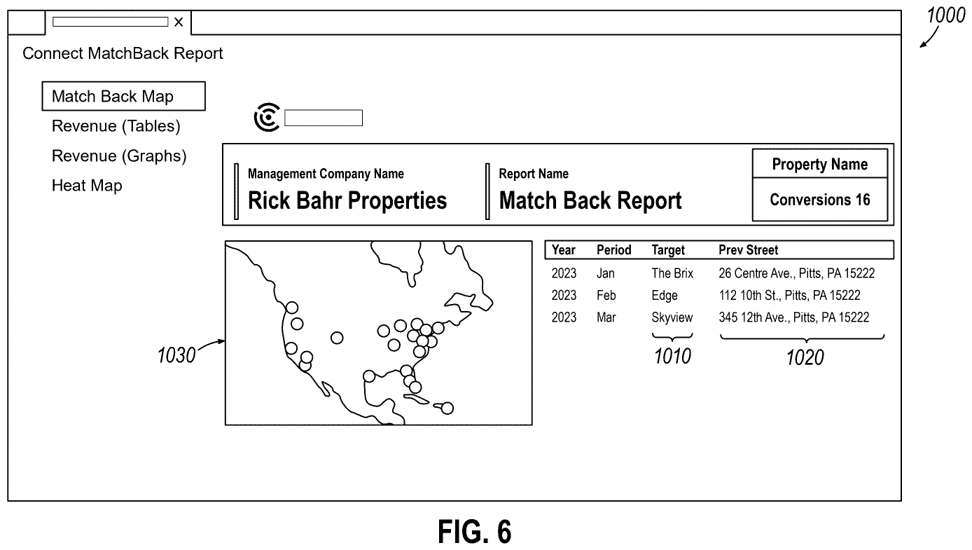

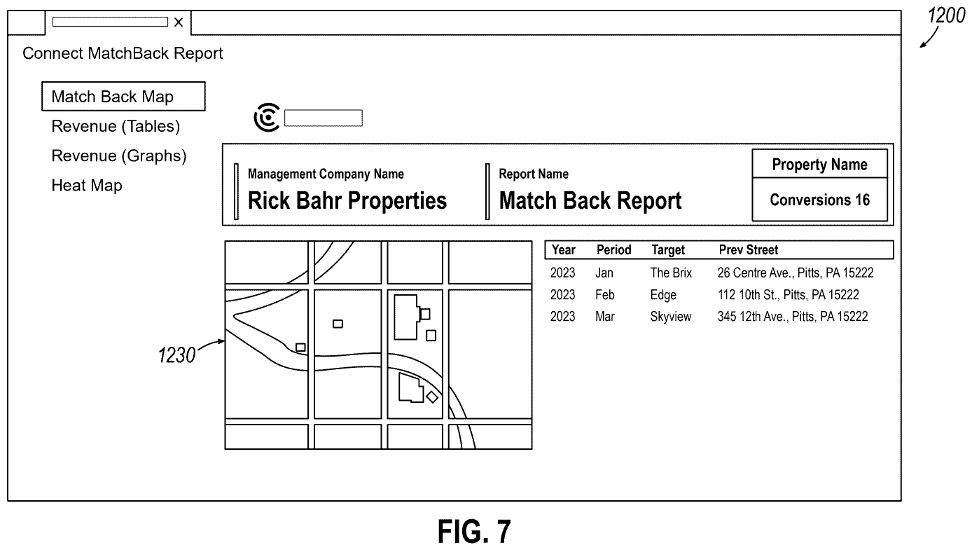

An embodiment of a match back report interface 1000, shown in FIG. 6, allows for valuable feedback on what target apartment complexes are the most fertile ground for targeted advertising. The data in match back report interface 1000 can come from comparing targeted competitor apartment complexes from apartment complex 75, location data from location services/servers 65, 60 and/or marketing data from marketing services/servers 85, 80 in FIG. 1. Such data may be used in the process of creating targeted marketing/advertising campaigns, as set forth regarding FIGS. 1 and 2. Match back report interface 1000 can show, as a result of a marketing campaign, what targeted apartment complexes are resulting in the greatest numbers of conversions to rent-paying tenants. For example, in FIG. 6 it can be seen that one conversion came from Edge Apartments and SkyVue Apartments. This data may need to be compared with advertising spend data, but assuming equal spends, the SkyVue apartments are a better target for advertising money than other unlisted apartments that were also targeted with advertising efforts. Or depending on spend amounts, it could be that the return to just one conversion from Edge is much greater than a larger advertising spend on SkyVue. Either way, the match back data provides a valuable way to judge advertising success. The target data 1010 shown in match back report interface 1000 may be obtained by comparing Previous Street data 1020 that comes from apartment applications at apartment complex 75. An applicant is required to list their previous address, which gets recorded and sent to, or accessed by, match back servers 50 and recorded as Previous Street data 1020. Match back servers 50 can then cross reference the previous address with known addresses of target apartment complexes, yielding the target data 1010. Map 1030 can show location data, such as target apartment complexes. Map 1030 can also allow zooming, as shown in alternative view of match report interface 1000 in FIG. 7. In match back report interface 1200 map 1230 shows a zoomed-in view of target apartment complexes.

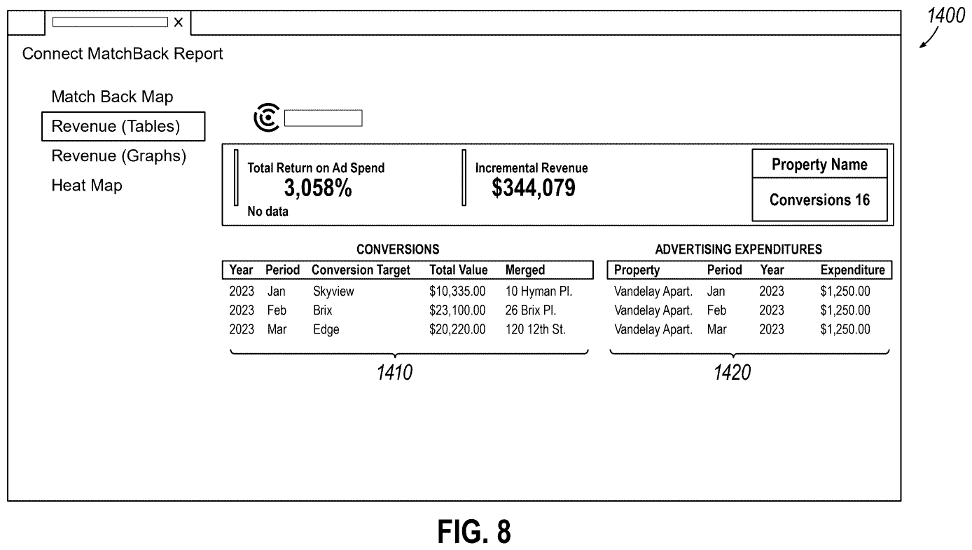

Another possible report interface is shown in FIG. 8. Spend report interface 1400 can show conversion data 1410 and advertising expenditure data 1420. Conversion data 1410 can show target apartment complexes and total value of conversions from that target apartment complexes. Advertising expenditure data 1420 can show advertising spends, e.g., per month for a given target apartment complex.

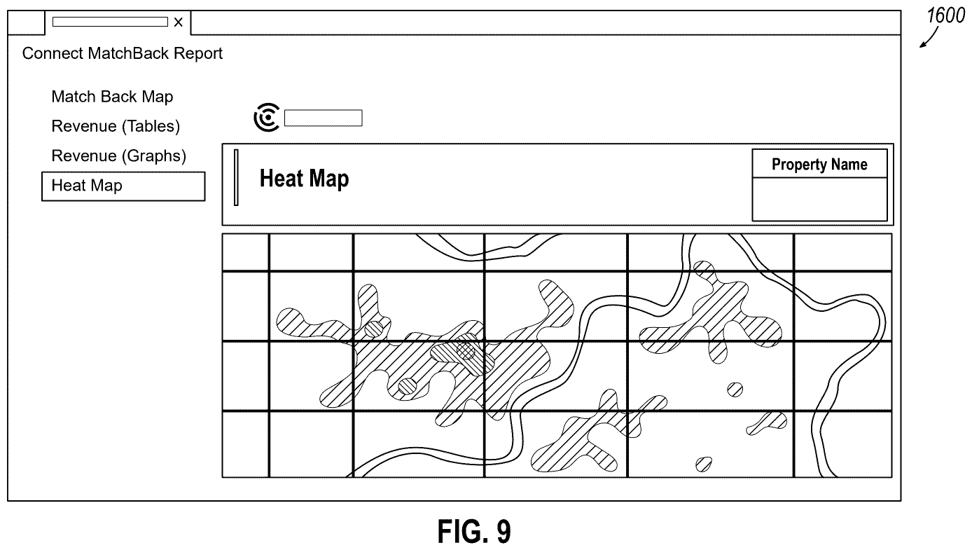

Another possible report interface is shown in FIG. 9. Heat map 1600 can show what target apartment complexes are “sending” the most tenants to the e.g. apartment complex 70 which is using match back services 55 to analyze match back data from marketing services 85 and location services 75.

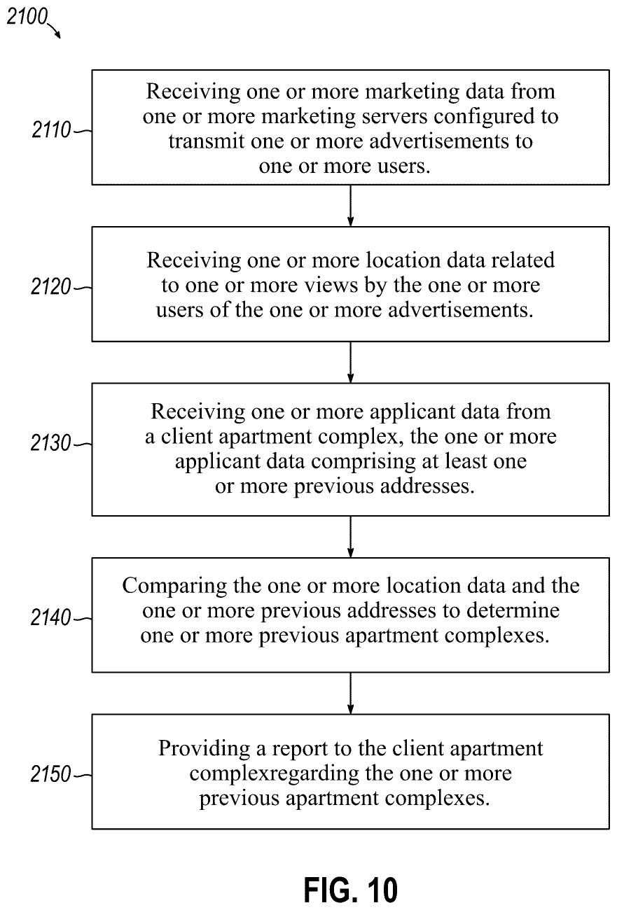

FIG. 10 illustrates a possible method embodiment 2100 under the present disclosure. Step 2110 is receiving one or more marketing data from one or more marketing servers configured to transmit one or more advertisements to one or more users. Step 2120 is receiving one or more location data related to one or more views by the one or more users of the one or more advertisements. Step 2130 is receiving one or more applicant data from a client apartment complex, the one or more applicant data comprising at least one or more previous addresses. Step 2140 is comparing the one or more location data and the one or more previous addresses to determine one or more previous apartment complexes. Step 2150 is providing a report to the client apartment complex regarding the one or more previous apartment complexes. Method 2100 can comprise a variety of optional, additional, or alternative steps and other variations.

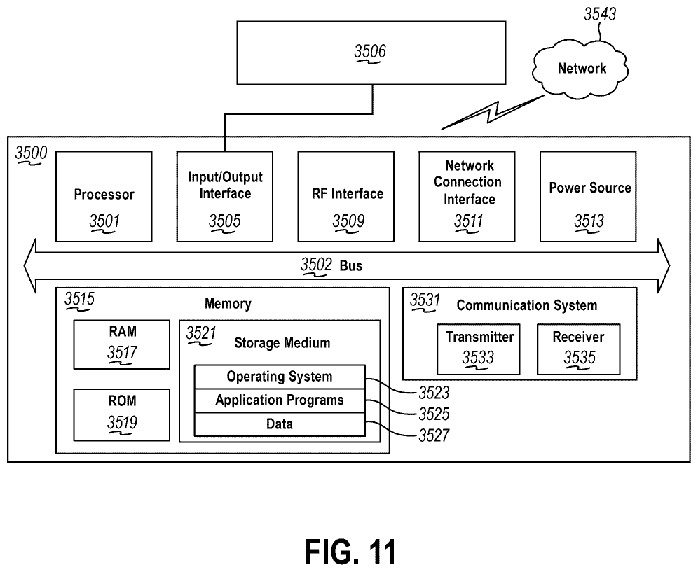

FIG. 11 illustrates an embodiment of various possible computing devices or any processor-based components within system 10 of FIG. 1, or components thereof e.g., match back servers 50, computing devices 35, 40, location servers 60, apartment servers 70, marketing servers 80; or other computing or smart devices described herein. FIG. 11 shows a schematic block diagram of a computing device 2500 (or components thereof) according to certain embodiments of the present disclosure.

Computing device 2500 includes processor 2501 that is operatively coupled via a bus 2502 to an input/output interface 2505, a power source 2513, a memory 2515, a RF interface 2509, network communication interface 2511, and/or any other component, or any combination thereof. The level of integration between the components may vary from one embodiment to another. Further, certain computing devices 2500 (or components thereof) may contain multiple instances of a component, such as multiple processors, memories, transceivers, transmitters, receivers, etc.

The processor 2501 is configured to process instructions and data and may be configured to implement any sequential state machine operative to execute instructions stored as machine-readable computer programs in memory 2515. Processor 2501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2501 may include multiple central processing units (CPUs).

In the example, input/output interface 2505 may be configured to provide an interface or interfaces to an input/output device(s) 2506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 2500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2513 is structured as a battery or battery pack. Other types of power sources, such as an external power source (e.g., an electricity outlet), photovoltaic device, or power cell, may be used. The power source 2513 may further include power circuitry for delivering power from the power source 2513 itself, and/or an external power source, to the various parts of computing device 2500 via input circuitry or an interface such as an electrical power cable.

Memory 2515 may be configured to include memory such as random-access memory (RAM) 2517, read-only memory (ROM) 2519, programmable read-only memory (PROM), erasable programmable read-only memory (EPROM), electrically erasable programmable read-only memory (EEPROM), magnetic disks, optical disks, hard disks, removable cartridges, flash drives, other storage medium 2521, and so forth. In one example, the memory 2515 includes one or more application programs 2525, an operating system 2523, web browser application, a widget, gadget engine, or other application, and corresponding data 2527. Memory 2515 may store, for use by the computing device 2500, any of a variety of various operating systems or combinations of operating systems. An article of manufacture, such as one including a simulation system or communication system may be tangibly embodied as or in memory 2515, which may be or comprise a device-readable storage medium.

Processor 2501 may be configured to communicate with an access network (such as network 20 of FIG. 1) or other network using the RF interface 2509 or network connection interface 2511. The RF interface 2509 or network connection interface 2511 may comprise one or more communication subsystems and may include or be communicatively coupled to an antenna. In the illustrated embodiment, communication functions of the RF interface 2509 or network connection interface 2511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Although the computing devices described herein (e.g., servers, computing devices, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored elsewhere, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

What is claimed is:

1. A method for aggregating location data, the method comprising:
receiving one or more marketing data from one or more marketing servers configured to transmit one or more advertisements to one or more users;
receiving one or more location data related to one or more views by the one or more users of the one or more advertisements;
receiving one or more applicant data from a client apartment complex, the one or more applicant data comprising at least one or more previous addresses;
comparing the one or more location data and the one or more previous addresses to determine one or more previous apartment complexes; and
providing a report to the client apartment complex regarding the one or more previous apartment complexes.

2. The method of claim 1 further comprising, generating a marketing campaign targeting potential residents based on the report to the client apartment complex.

3. The method of claim 2 wherein, generating a marketing campaign comprises identifying target audiences in targeted areas.

4. The method of claim 3 wherein, generating a marketing campaign further comprises sending targeted digital advertisements to the target audiences.

5. The method of claim 2 further comprising, matching an applicant to a marketing campaign to establish attribution.

6. The method of claim 1 further comprising, generating a quantitative return on investment metric based on the marketing campaign.

7. A system for aggregating location data and marketing data, the system comprising:
processing circuitry; and
a memory comprising instructions performable by the processing circuitry, whereby the instruction are configured for the processing circuitry to perform any of the steps of:
receiving one or more marketing data from one or more marketing servers configured to transmit one or more advertisements to one or more users;
receiving one or more location data related to one or more views by the one or more users of the one or more advertisements;
receiving one or more applicant data from a client apartment complex, the one or more applicant data comprising at least one or more previous addresses;
comparing the one or more location data and the one or more previous addresses to determine one or more previous apartment complexes; and
providing a report to the client apartment complex regarding the one or more previous apartment complexes.

8. The system of claim 7, the instructions further comprising generating a marketing campaign targeting potential residents based on the report to the client apartment complex.

9. The system of claim 8, the instructions further comprising identifying target audiences in targeted areas.

10. The system of claim 9, the instructions further comprising sending targeted digital advertisements to the target audiences.

11. The system of claim 8, the instructions further comprising matching an applicant to a marketing campaign to establish attribution.

12. The system of claim 8, the instructions further comprising generating a quantitative return on investment metric based on the marketing campaign.

13. A system for aggregating location data and marketing data, the system comprising:
a marketing interface configured to receive one or more marketing data from one or more marketing servers configured to transmit one or more advertisements to one or more users;
a geo-fencing interface configured to receive one or more location data related to one or more views by the one or more users of the one or more advertisements;
an apartment interface configured to receive one or more applicant data from a client apartment complex, the one or more applicant data comprising at least one or more previous addresses;
one or more match back servers coupled to the marketing, geo-fencing, and apartment interfaces, and configured to compare the one or more location data and the one or more previous addresses to determine one or more previous apartment complexes.

14. The system of claim 13, wherein the one or more match back servers are further configured to provide a report to the client apartment complex regarding the one or more previous apartment complexes.

15. The system of claim 14, wherein the one or more match back servers are further configured to generate a marketing campaign based on the report to the client apartment complex.

16. The system of claim 15, wherein the match back servers are further configured to send targeted digital advertisements to the target audiences based on the marketing campaign.

17. The system of claim 13, wherein the report to the client apartment complex comprises a spend report interface comprising conversion data and advertising expenditure data.

18. The system of claim 13, wherein the match back servers, geo-fencing interface, apartment interface, and marketing interface are co-located.

19. The system of claim 13, wherein the match back servers are further configured to match an applicant to a marketing campaign to establish attribution.

20. The system of claim 13, wherein the match back servers are further configured to generate a quantitative return on investment metric based on the marketing campaign.
